(19) United States
(12) Patent Application Publication
(10) Pub. No.: US 2014/0217789 A1
(43) Pub. Date: Aug. 7, 2014

(54) SMART VEHICULAR HEADREST VIDEO ENTERTAINMENT SYSTEM

(71) Applicant: Arthur Shi CHANG, New Taipei City (TW)

(72) Inventor: Arthur Shi CHANG, New Taipei City (TW)

(21) Appl. No.: 13/761,995

(22) Filed: Feb. 7, 2013

(51) Int. Cl. B60N 2/48

(52) U.S. Cl. CPC B60N 2/4876
USPC 297/217.4

(57) ABSTRACT

A smart vehicular headrest video entertainment system is adapted for use with a means of transport having a headrest and adapted for passengers to select one of a first video signal and a second video signal. The system includes a casing, a displaying unit, a processing unit, a video unit, and a connection unit. The casing fits into or onto the headrest. The displaying unit is received in the receiving space, has a control interface, and interacts with the passengers through the control interface, so as to generate a control signal and display the first video signal and the second video signal. The processing unit receives the control signal and operates the video unit according to the control signal or operates the multimedia device through the communication port. The processing unit sends the first video signal or the second video signal to the displaying unit.

### FIELD OF THE INVENTION

The present invention relates to video entertainment systems, and more particularly, to a smart vehicular headrest video entertainment system for use with a means of transport, wherein the means of transport is equipped with a headrest.

### BACKGROUND OF THE INVENTION

According to the prior art, a means of transport is designed to carry multiple passengers. To render a ride less boring, a means of transport nowadays is typically equipped with a multimedia video playing system.

However, the multimedia video playing system generates a broadcast video signal. As a result, all passengers receive the same video signal. The video signal is controlled by a video main controller and is not subject to any changes made on the part of the passengers.

In view of the aforesaid drawback of the prior art, the video system evolves in a way to allow the video main controller to provide a plurality of video signals to be selected by the passengers, but still has its own drawbacks in terms of restriction of use.

Accordingly, it is imperative to put forth a system whereby the passengers can select the video signals freely.

### SUMMARY OF THE INVENTION

It is an objective of the present invention to provide a smart vehicular headrest video entertainment system whereby passengers riding a means of transport can select a video unit (such as a DVD player built in the entertainment system) freely or watch a video signal with a multimedia device (such as a smart mobile device.)

Another objective of the present invention is to provide the smart vehicular headrest video entertainment system comprising a displaying unit integrated into the video unit and the multimedia device, such that passengers can operate the video unit and the multimedia device directly by means of the displaying unit.

Yet another objective of the present invention is to provide the smart vehicular headrest video entertainment system that supports the multimedia device, wherein the multimedia device conforms to a communication protocol pertaining to Apple's 30-pin connectors or Apple's 8-pin connectors.

In order to achieve the above and other objectives, the present invention provides a smart vehicular headrest video entertainment system adapted for use with a means of transport having a headrest and adapted for passengers to select one of a first video signal and a second video signal. The system comprises a casing, a displaying unit, a processing unit, a video unit, and a connection unit. The casing fits into or onto the headrest and forms a receiving space. The displaying unit is received in the receiving space, has a control interface, and interacts with the passengers through the control interface, so as to generate a control signal and display the first video signal and the second video signal. The processing unit is connected to the displaying unit and adapted to receive the control signal. The video unit is connected to the processing unit and adapted to generate the first video signal. The connection unit has a communication port, connects to an external multimedia device via the communication port, and receives the second video signal generated from the multimedia device. The processing unit operates the video unit according to the control signal, operates the multimedia device through the communication port, and sends one of the first video signal and the second video signal to the displaying unit.

Accordingly, a smart vehicular headrest video entertainment system of the present invention not only enables passengers riding a means of transport (especially passengers sitting at the rear of the means of transport) to operate independently a video unit (including at least an external media source) built in the entertainment system, but also provides a port connectable to a multimedia device (such as a smart mobile device) available for use by the passengers, such that passengers can control the video unit and the multimedia device directly with the entertainment system.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic block diagram of a smart vehicular headrest video entertainment system according to the first embodiment of the present invention;

FIG. 2 is a schematic view of the smart vehicular headrest video entertainment system disposed at a headrest in the first embodiment of FIG. 1; and

FIG. 3 is a schematic block diagram of the smart vehicular headrest video entertainment system according to the second embodiment of the present invention.

### DETAILED DESCRIPTION OF THE PREFERRED EMBODIMENTS

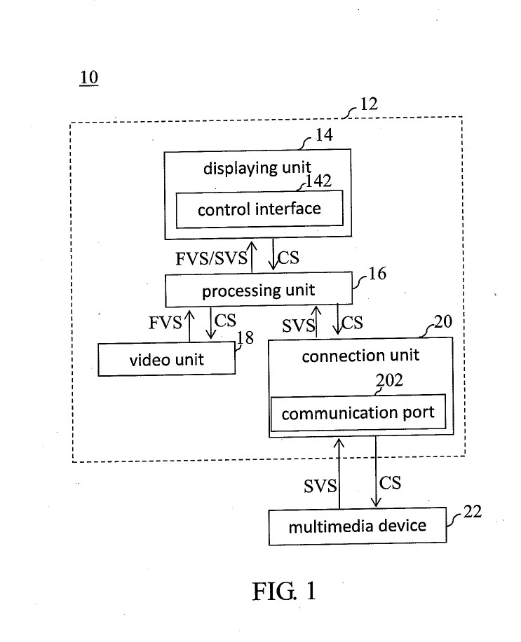

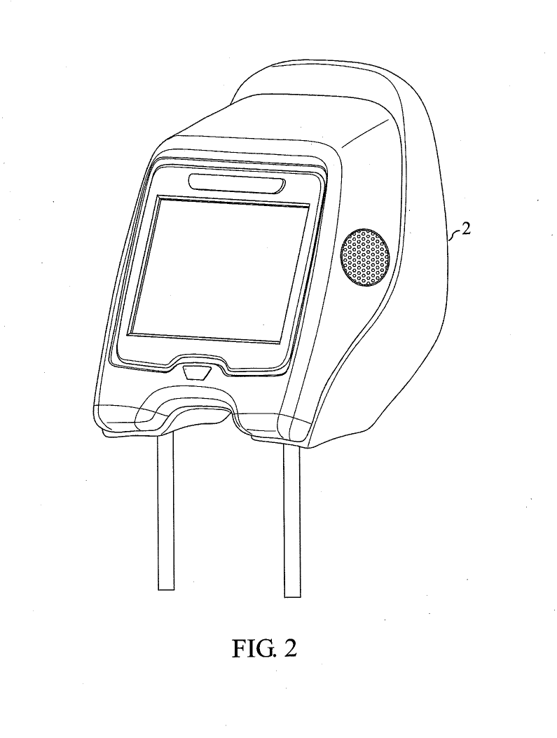

Referring to FIG. 1, there is shown a schematic block diagram of a smart vehicular headrest video entertainment system 10 according to the first embodiment of the present invention. As shown in FIG. 1, the smart vehicular headrest video entertainment system 10 is for use with a means of transport which is equipped with a headrest 2 shown in FIG. 2, such that passengers riding the means of transport can select a first video signal FVS or a second video signal SVS. For example, the means of transport is a vehicle or an aircraft. The means of transport is furnished with a plurality of seats (not shown). Each of the seats has a pad for the passenger to sit on and has the headrest 2 for supporting the passenger's head. The smart vehicular headrest video entertainment system 10 of the present invention fits into the headrest 2.

Referring to FIG. 1, the smart vehicular headrest video entertainment system 10 comprises a casing 12, a displaying unit 14, a processing unit 16, a video unit 18, and a connection unit 20.

The casing 12 fits into or onto the headrest 2 shown in FIG. 2. The casing 12 forms a receiving space. The displaying unit 14, the processing unit 16, the video unit 18, and the connection unit 20 are received in the receiving space. Hence, the smart vehicular headrest video entertainment system 10 is characterized in that its constituent elements are confined to the headrest 2 by means of the casing 12.

The displaying unit 14 has a control interface 142. The displaying unit 14 not only interacts with the passengers through the control interface 142 to generate a control signal CS, but also displays the first video signal FVS and the second video signal SVS. In this embodiment, the displaying unit 14 exemplified by a liquid crystal display (LCD), but the displaying unit 14 of the present invention is not limited thereto. In practice, a unit will satisfy the definition of the displaying unit 14 of the present invention, provided that the unit displays the first video signal FVS and the second video signal SVS.

The control interface 142 of the displaying unit 14 includes at least one of a key switch and a touchscreen, as described below.

As regards the key switch, the key switch is disposed at the displaying unit 14. When pressed or rotated by a passenger, the key switch triggers the displaying unit 14 to generate the control signal CS. For example, the key switch is a selection switch or a power switch pertaining to volume, brightness, setting, channels, the first video signal, and the second video.

As regards the touchscreen, the touchscreen is attached to the displaying unit. The passengers change the resistance or capacitance of the touchscreen in order to generate the control signal CS. The passengers selectively touch a touchscreen (disposed on the displaying unit 14 but is not shown in the diagram) that displays the selection switch or the power switch pertaining to volume, brightness, setting, channels, the first video signal, and the second video, so as to generate the control signal CS related to the aforesaid functions.

The processing unit 16 and the displaying unit 14 are connected. The processing unit 16 receives the control signal CS and operates according to the control signal CS. The operation performed by the processing unit 16 is for use in operating the video unit 18 or the multimedia device 22 connected to the connection unit 20.

The video unit 18 generates the first video signal FVS, whereas the multimedia device 22 generates the second video signal SVS, as described below.

As regards the video unit 18, in this embodiment, the video unit 18, which is a video player built in the smart vehicular headrest video entertainment system 10, comprises at least an external media source, such as a DVD player or a memory card reader. For example, the video unit 18 enables the passengers to insert a DVD or a memory card to thereby read the DVD with a DVD drive or read medium contents from the memory card with a memory card reader, so as to generate the first video signal FVS corresponding to the medium contents.

As regards the multimedia device 22, in this embodiment, the multimedia device 22 is a smart mobile device being used by the passengers. For example, the smart mobile device is a mobile phone, tablet, iPOD, iPAD, or iPhone. Hence, the smart mobile device does not fit into the smart vehicular headrest video entertainment system 10. After the multimedia device 22 has been connected to the smart vehicular headrest video entertainment system 10, the processing unit 16 takes over the control over the multimedia device 22, such that the passengers can operate the multimedia device 22 by means of the displaying unit 14 and the processing unit 16. For instance, after the multimedia device 22 has been connected to the smart vehicular headrest video entertainment system 10, the processing unit 16 becomes in charge, and displays the operating interface of the multimedia device 22 on the displaying unit 14 in a mapping manner, such that the passengers can operate the multimedia device 22 directly through the operating interface displayed on the displaying unit 14.

The smart vehicular headrest video entertainment system 10 is connected to the multimedia device 22 via the connection unit 20 having a communication port 202. For instance, the communication port 202 is intended for wire communication or wireless communication. The second video signal SVS is transmitted between the connection unit 20 having the communication port 202 and the multimedia device 22 by wire communication or wireless communication. When it comes to wire communication, the communication port 202 conforms to a communication protocol of at least one of Apple link, universal serial bus (USB), IEEE 1394, and composite video connector. When it comes to wireless communication, the communication port 202 conforms to a communication protocol of at least one of Wi-Fi, third generation mobile communication, and fourth generation mobile communication.

After the connection unit 20 has been connected to the multimedia device 22 via the communication port 202, the connection unit 20 receives the second video signal SVS generated from the multimedia device 22. A video signal and an audio signal of the second video signal SVS are sent to the communication port 202 by means of a transmission line. Alternatively, the video signal is transmitted by a video signal transmission line, whereas the audio signal is transmitted by an audio transmission line. Selection of a means of transmission is actually related to a communication protocol of the communication port 202. Take Apple link as an example, in fact, the pins of Apple link comprise video signal transmission pins for transmitting the video signal and audio signal transmission pins for transmitting the audio signal. Hence, although the connection unit 20 and the multimedia device 22 are connected by a transmission line, the transmission line is capable of transmitting the video signal and the audio signal too.

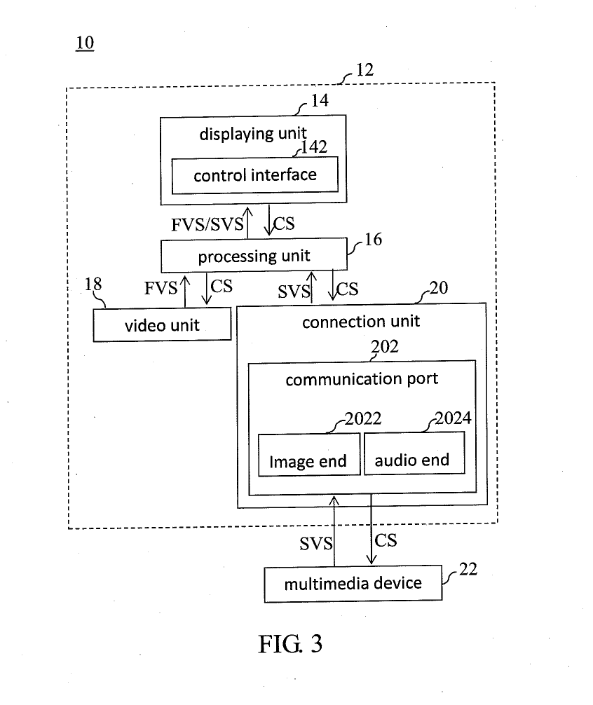

In another embodiment, as shown in FIG. 3, the communication port 202 further comprises an image end 2022 and an audio end 2024. The communication port 202 receives via the image end 2022 a video-related portion of the second video signal SVS sent from the multimedia device 22. The communication port 202 receives via the audio end 2024 an audio-related portion of the second video signal SVS sent from the multimedia device 22.

Accordingly, the present invention provides a smart vehicular headrest video entertainment system which not only enables passengers riding a means of transport (especially passengers sitting at the rear of the means of transport) to operate a video unit built in the entertainment system, but also provides a communication port connectable to a multimedia device available to the passengers, such that the passengers can directly control the video unit and the multimedia device by means of the entertainment system.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A smart vehicular headrest video entertainment system adapted for use with a means of transport having a headrest and adapted for passengers to select one of a first video signal and a second video signal, the smart vehicular headrest video entertainment system comprising:
a casing fitting into or onto the headrest and forming a receiving space;
a displaying unit received in the receiving space, having a control interface, and interacting with the passengers through the control interface, so as to generate a control signal and display the first video signal and the second video signal;
a processing unit connected to the displaying unit and adapted to receive the control signal;
a video unit connected to the processing unit and adapted to generate the first video signal; and
a connection unit having a communication port, connected to an external multimedia device via the communication port, and adapted to receive the second video signal generated from the multimedia device,
wherein the processing unit operates the video unit according to the control signal, operates the multimedia device through the communication port, and sends one of the first video signal and the second video signal to the displaying unit.

2. The smart vehicular headrest video entertainment system of claim 1, wherein the control interface includes at least one of a key switch and a touchscreen and enables the passengers to generate the control signal through the key switch and/or the touchscreen.

3. The smart vehicular headrest video entertainment system of claim 2, wherein the video unit includes at least an external media source.

4. The smart vehicular headrest video entertainment system of claim 3, wherein the communication port operates by wire communication or wireless communication, such that the connection unit receives the second video signal from the multimedia device via the communication port by wire communication or wireless communication.

5. The smart vehicular headrest video entertainment system of claim 4, wherein the communication port conforms to a communication protocol of at least one of Wi-Fi, third generation mobile communication, and fourth generation mobile communication.

6. The smart vehicular headrest video entertainment system of claim 4, wherein the communication port comprises an image end and an audio end, receives via the image end a video-related portion of the second video signal sent from the multimedia device, and receives via the audio end an audio-related portion of the second video signal sent from the multimedia device.
